(19) United States
(12) Patent Application Publication
(10) Pub. No.: US 2015/0285227 A1
(43) Pub. Date: Oct. 8, 2015

(54) Submersible gravity and thermal energy generator

(71) Applicant: Yanming Wei, Mountain (CA)

(72) Inventor: Yanming Wei, Mountain (CA)

(21) Appl. No.: 14/245,397

(22) Filed: Apr. 4, 2014

(51) Int. Cl. F03G 7/05

(52) U.S. Cl. CPC F03G 7/05

(57) ABSTRACT

A generator apparatus and method that can work only when the temperature at higher position is colder than temperature at lower position, utilize the gravity energy that is caused by height difference. The boiling point of working fluid is about around the temperature of bottom. The vaporization function will raise the vapor to the top end heat exchanger along the vertical vapor pipe. The top end is exposed in colder ambient, so the vapor will be condensed quickly to liquid, then free fall to bottom end along another vertical liquid pipe. At the bottom, a hydro-wheel generator or dedicated fluid kinetic generator is used to connect the liquid pipe and vaporization tray. If the bottom end is under the water body, most part of the system should be waterproof for submersible application. Most likely the present invention is suitable for cold belt or glacier zone geographically.

In a sense, the invention looks like to artificially simulate the natural water circulation. Although the vaporization in bottom end can bring expansion energy, for maximizing the flow rate in order to maximize gravity power, the fluid kinetic generator is supposed to harvest all energy accumulated in the “artificial rain”—the free fall condensed working fluid.

### BACKGROUND

The residents that are living in cold belt, permafrost or glacier zone, always expect an efficient power generator that can take advantage of their cold atmosphere environment.

In winter, the lowest temperature in Canada and north of USA or other high latitude area can be as low as −40 Celsius degree, or say −40 Fahrenheit degree. In contrast, the temperature on the bottom of water body or just underneath ice sheet is about 4 Celsius degree (about 40 Fahrenheit degree). The temperature difference is about 44 both in Celsius degree and Kelvin degree. If a heat engine works on the temperature difference, according to the Carnot cycle theory, the maximal thermal-work efficiency is about 44/(273+4)*100%=16%. Although not high enough, however 16% is more appreciated compared with the existing regular commercial ocean temperature difference power plant that works on only small temperature difference of about 20 Celsius degree.

In the above mentioned geographic zones, the cold climate may last for 6 months, or even as more as to year round in arctic zone. This makes it is so necessary and feasible to develop a novel heat engine to harvest the ‘cold power’.

The low energy density and high cost of heat exchanger and expander and compressor and pump significantly frustrates the economic feasibility. If thermal energy is only used to make liquid vaporized and naturally lift vapor from low position to high position, then thermal energy is transferred to gravity energy, and more profoundly high cost components greatly reduced. But the energy density of gravity energy depends on the matter density, so the vapor should be liquefied for gravity energy harvest. The quick natural liquidation needs the cold ambient. So high end low temperature is a must for the transfer of thermal to gravity energy.

Hydropower is a mature and economic feasible technology for harnessing liquid gravity energy. Nowadays, even micro-hydropower system of 1 kw to 10 kw is widely developed. For example, U.S. Pat. No. 6,357,997 B1 discloses a micro-hydropower device that fits as low as 4 meters low water head. The patented 2 kw portable mini-hydropower generator is manufactured with only 40 lbs weight.

### PRIOR ART

Ocean thermal energy conversion (OTEC) uses the temperature difference between cooler deep and warmer shallow or surface ocean waters to run a heat engine and produce useful work, usually in the form of electricity. OTEC is a base load electricity generation system, i.e. 24 hrs/day all year long. However, the temperature differential is small and this impacts the economic feasibility of ocean thermal energy for electricity generation.

Systems may be either closed-cycle or open-cycle. Closed-cycle engines use working fluids that are typically thought of as refrigerants such as ammonia or R-134a. These fluids have low boiling points, and are therefore suitable for powering the system's generator to generate electricity. The most commonly used heat cycle for OTEC to date is the Rankine cycle using a low-pressure turbine. Open-cycle engines use vapor from the seawater itself as the working fluid.

In 1974, The U.S. established the Natural Energy Laboratory of Hawaii Authority (NELHA) at Keahole Point on the Kona coast of Hawaii. Hawaii is the best US OTEC location, due to its warm surface water, access to very deep, very cold water, and high electricity costs. The laboratory has become a leading test facility for OTEC technology. The effort is endless since then and many entities are involved. In July 2011, Makai Ocean Engineering completed the design and construction of an OTEC Heat Exchanger Test Facility at the Natural Energy Laboratory of Hawaii. The purpose of the facility is to arrive at an optimal design for OTEC heat exchangers, increasing performance and useful life while reducing cost (heat exchangers being the #1 cost driver for an OTEC plant). And in March 2013, Makai announced an award to install and operate a 100 kilowatt turbine on the OTEC Heat Exchanger Test Facility, and once again connect OTEC power to the grid.

Unfortunately, none of existing prior art shows a groundbreaking advance in mitigating the frustration of economic feasibility caused by energy density and high cost of heat exchanger and expander and compressor.

The issued U.S. Pat. No. 6,357,997 B1-RIBBON DRIVE POWER GENERATION APPARATUS AND METHOD does introduce a lightweight micro-hydropower generator solution. Although the present invention can use regular low cost hydro-wheel generator, it is still recommended to combine this 3^{rd} party patent to optimize the system performance.

### BRIEF DESCRIPTION OF THE DRAWING AND PREFERRED EMBODIMENTS

The illustrative embodiments described in the description, drawings, and claims are not meant to be limiting. The features of the embodiments and figures described and shown herein can be used and combined with other features of other embodiments as well as figures. Some features may bear less importance, and therefore optional.

Other embodiments may be utilized, and other changes may be made, without departing from the spirit or scope of the subject matter presented herein. It will be readily understood that the aspects of the present disclosure, as generally described herein, and illustrated in the figures, can be arranged, substituted, combined, separated, and designed in a wide variety of different configurations, all of which are explicitly contemplated herein.

FIG. 1 is the system scheme.

The water surface (1) may be frozen, and becomes ice sheet in winter. If so, then the system installation should break the ice sheet first for sinking the big working fluid tank (7) and other components. The tank (7) is not totally full filled for the convenience of vaporization, but it is preferred that the inside fluid level (10) should have as bigger area as possible for quick vaporization, as well as the inside fluid height is not necessarily over thick provided the total fluid mass satisfies whole system power rating.

For robust installation, the fluid tank (7) may have some legs (13) for sitting on water bed ground (12), and the vertical vapor pipe (3) and liquid pipe (5) may have fixtures (4) to sit on ice sheet (1). If ice sheet is thick enough, and rated system power is only for household use, then the whole system weight may be light, and may sit only on ice sheet (1) without footing legs on deep water bed.

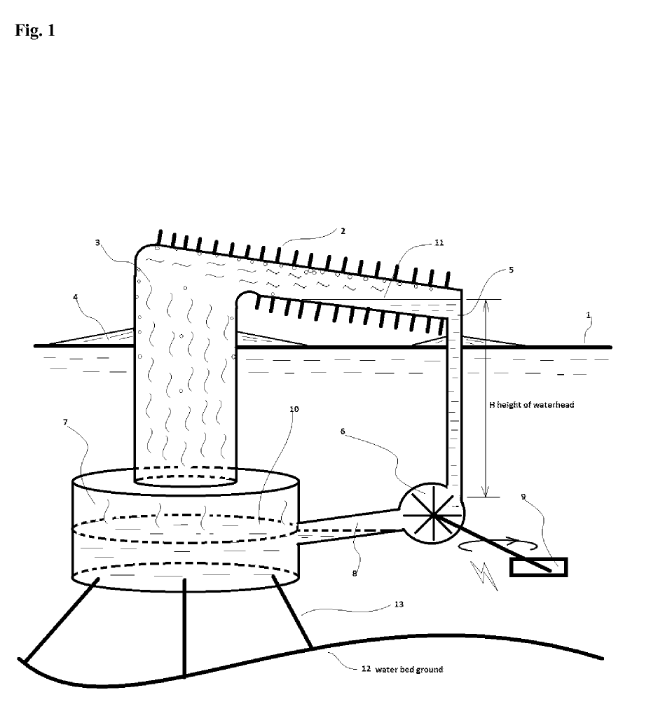

Above surface of water, the vapor pipe (3) and liquid pipe (5) are connected via heat exchanger (11) for condensing vapor to liquid. The FIG. 1 illustrates a simple heat exchanger with a plurality of fins (2), but it can be any form of good rated heat exchanger.

As the liquefied fluid free falls down the liquid pipe (5), the kinetic energy will be transferred to the vanes of hydro-wheel (6). An electricity generator (9) is coupled with the hydro-wheel (6) shaft, then electricity power is generated when system working.

The hydro-wheel (6) and tank (7) is connected via a pipe (8) that feeds the working fluid from hydro-wheel (6) outlet to tank (7) inlet.

To facilitate the working fluid circulation with gravity, the heat exchanger (11) should be inclined to liquid pipe (5), as well as pipe (8) should be inclined to tank (9).

The hydro-power assembly that comprises hydro-wheel (6) and generator (9), may be replaced by other dedicated hydro-power device. The 3^{rd} U.S. Pat. No. 6,357,997 B1-RIBBON DRIVE POWER GENERATION APPARATUS AND METHOD is recommended for micro-hydropower application. Whatever scenario applied, the waterproof measurement should be considered because of the submersible application.

The criteria for choosing working fluid: boiling point should be close to bottom end temperature, and the saturation pressure at normal temperature should not be too high, and less impact to environment.

Some candidate working fluid as examples:

i. Hexafluoropropane (R236fa) Boiling point: −1.5 Celsius degree at 1 atm (standard atmosphere pressure), specific weight 1.45; saturation point 1: −30° C./0.25 atm; saturation point 2: 50° C./5.8 atm

ii. Butane Boiling point: −0.5° C. at 1 atm, specific weight: saturation point 1: −30° C./0.27 atm; saturation point 2: 50° C./4.9 atm

Butane is flammable, for safety consideration, fire should be avoided nearby the system or try to select other fluid.

In FIG. 1, the marked “H” stands for the height of water head, though the wording of “fluid head” may be more general or precious than the conventional wording “water head”, because the working fluid in present invention is not water, but well selected other specific fluid. The system output power is proportional to the water head H and the flow rate.

Calculation for sample embodiment:

Working fluid: R236fa The water head height H=10 meter. Power rating 2 kw R236fa is heavier 45% more than water. So 1 meter water head of R236fa is equivalent to 1.45 meters water head of water. Try to calculate the mass M of R236fa for the 2 kw power rating. Because the gravity energy is to be converted to kinetic energy when free fall from height H to bottom, then:

MGH=(½)M*V*V;

V=SquareRoot(*G*H);

Assume the gravitational acceleration G approximately 10 m/s/s for rough estimation, though 9.8 more accurate.

For herein application, the velocity at bottom V=SquareRoot(*10*10)=14 m/s.

The free fall time T can be calculated from: V=G*T;

Then T=SquareRoot(*G*H)/G=SquareRoot(*H/G) For herein application, T=1.41 seconds;

Assume the mass M can continually fall down in the fluid stream, then the power: P=Works/T=M*G*H/SquareRoot(*H/G)=0.707*M*G*SquareRoot(G*H)=21.7*M*SquareRoot(H);

M=0.046*P/SquareRoot(H);

For herein application, P=2000 watts, so M=28 kg (kilogram). The volume of R236fa is 28/1.45=19 liters. The fluid flow rate=19L/1.41s =13.4 liters per second, or about 295 GPM (gallons per minutes). Of course the total R236fa volumes should far greater than the liters that fall down within one second for stable working, perhaps 5 times is OK, then 100 liters R236fa is needed for the power system.

Possible alteration for summer application:

Although the main object climate is for winter, it is still possible to modify configuration for summer usage.

Basically the system top end temperature should be littler than bottom end for gravity works in present patent. However air ambient temperature is higher than water body during summer time. So the hot air should be conducted to underneath of water for proper use.

A big chimney-like waterproof L-shape channel with an open air end and a closed end can be soaked in water deep to rated height. Make the L-shape structure firmly sitting on underwater bed, if float force greater than the gross weight, some adequate measurements should be done to overcome it. Now hot air can go to the bottom of L-shape empty structure.

Two big holes should be drilled on the upper surface of the L-shape bottom level for fitting the vapor pipe and liquid pipe with proper sealing to prevent water from leaking into air channel.

Fluid container and hydro-wheel generator now can be installed in the open air inner space of bottom of L-shape channel. And submersedly heat exchanger connects both top ends of vapor pipe and liquid pipe.

Unfavorably the summer temperature difference is only about 10 to 30 Celsius degree, almost half cut compared to winter application. But it is still working with just lower power rating.

The invention may be embodied in other specific forms without departing from its spirit or essential characteristics. The described embodiments are to be considered in all respects only as illustrative and not restrictive and the scope of the invention is, therefore, indicated by the appended claims rather than by the foregoing description. All changes, for example, round container to square container and so on, which come within the meaning and range of equivalency of the claims are to be embraced within their scope.

I claim:

1. A power generator system based on thermal and gravity energy, comprising:
container of working fluid that absorbs thermal energy at bottom ambient to massively produce vapor;
vapor pipe that is vertical positioned and provides pass way for rising vapor;
heat exchanger that is horizontally slight inclined to outlet end and condenses the vapor to liquid;
liquid pipe that is vertical positioned and provides pass way for liquid free fall;
hydro-wheel or turbine that liquid linear kinetic energy to ration energy;
and return pipe that is horizontally slight inclined to container and conducts the exhausted liquid to container for next vaporization circle.

2. The said power generator system in claim 1, wherein bottom end temperature should be greater than top end for system proper working.

3. The said power generator system in claim 1, wherein an electricity generator is coupled with shaft of hydro-wheel or turbine.

4. The said power generator system in claim 1, wherein some parts or subsystem may be submersed in water, then proper sealing should be assured.

5. The said power generator system in claim 1, wherein the boiling point of working fluid should be close to bottom ambient temperature.
